(19) United States
(12) Patent Application Publication
(10) Pub. No.: US 2006/0101203 A1
(43) Pub. Date: May 11, 2006

(54) Storage virtualization apparatus

(75) Inventor: Toshitaka Yanagisawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU COMPUTER TECHNOLOGIES LIMITED, Kawasaki (JP)

(21) Appl. No.: 11/066,488

(22) Filed: Feb. 28, 2005

(30) Foreign Application Priority Data
Nov. 9, 2004 (JP) 2004-324709

(51) Int. Cl. G06F 13/00

(52) U.S. Cl. 711/114; 711/170

(57) ABSTRACT

The storage virtualization apparatus is capable of identifying a host computer or computers within an extent of influence and restraining of the extent when a physical storage enclosure has a breakdown or stops. The storage virtualization apparatus of the present invention comprises: first connection means for connecting to a host computer; second connection means for communicating with a plurality of physical storage enclosures; virtualization means for making the host computer recognize a storage area constituted by parts or all of storage areas of the physical storage enclosures as a virtual storage enclosure or enclosures; and grouping means for dividing the physical storage enclosures into a plurality of groups so as to constitute each virtual storage enclosure with the storage areas of the physical storage enclosures in the same group.

### BACKGROUND OF THE INVENTION

The present invention relates to a storage virtualization apparatus, more precisely relates to a storage virtualization apparatus, which will be connected to a host computer and a plurality of physical storage enclosures and which makes the host computer recognize storage areas of the physical storage enclosures as a virtual storage enclosure or enclosures.

Conventionally, in a computer system for processing a large amount of data, a plurality of sever computers are employed to perform distributed processing, and a plurality of physical storage enclosures are commonly used by the server computers.

In case of commonly using a plurality of physical hard disk enclosures by a plurality of server computers, a combined storage areas of the physical hard disk enclosures is recognized by the server computers as a virtual storage enclosure so as to simplify processes of accessing the physical hard disk enclosures by the server computers (see Japanese Patent Gazette No. 2003-44421).

Virtualization of physical storage enclosures will be explained with reference to FIG. 2.

A plurality of server computers H and a plurality of physical hard disk enclosures (storage enclosures) S1, S2 and S3, each of which has memory capacity (storage area) of 10 gigabytes (GB), are connected to a storage virtualization apparatus 90. The storage virtualization apparatus 90 makes the server computers H recognize the physical hard disk enclosures S1, S2 and S3, each of which has memory capacity of 10 GB, as a virtual hard disk enclosure (storage enclosure) 92 having a storage area of 30 GB, which is a combination of storage areas of the physical hard disk enclosures S1, S2 and S3.

By accessing the virtual storage enclosure 92, the server computers H can use the hard disk enclosures S1, S2 and S3 without concerning storage capacities, connection forms, etc. of each of the physical hard disk enclosures S1, S2 and S3.

However, the conventional virtualization apparatus has following disadvantages.

In FIG. 2, if one of the hard disk enclosures S1, S2 and S3 has a breakdown or is stopped for maintenance, it is difficult to know which server computer H is influenced. An extent of influence relating to the breakdown or stop may be broad. Therefore, despite one of the hard disk enclosures S1, S2 and S3 has a breakdown, all of the sever computers H often stops to recover.

Prescribed characteristics, e.g., performance, reliability, are required to the physical hard disk enclosures according to use of the server computers H. In the system shown in FIG. 2 including the conventional storage virtualization apparatus 90, if one of the hard disk enclosures S1, S2 and S3 has insufficient characteristics, e.g., performance, reliability, the characteristics of the virtual hard disk enclosure 92 must be insufficient.

Namely, even if other physical hard disk enclosures have enough characteristics, the total characteristics of the virtual hard disk enclosure 92 must be lowered by the insufficient physical hard disk enclosure so that the server computers H cannot be sufficiently used. Thus, another physical hard disk enclosure or another storage system must be required. Providing another physical hard disk enclosure and another storage system are uneconomic.

### SUMMARY OF THE INVENTION

The present invention has been invented to overcome the disadvantages of the conventional technology.

An object of the present invention is to provide a storage virtualization apparatus, which is capable of identifying a host computer or computers within an extent of influence and restraining of the extent when a physical storage enclosure has a breakdown or stops.

Another object is to provide a storage virtualization apparatus having sufficient characteristics required by a host computer.

To achieve the objects, the storage virtualization apparatus of the present invention comprises: first connection means for connecting to a host computer; second connection means for communicating with a plurality of physical storage enclosures; virtualization means for making the host computer recognize a storage area constituted by parts or all of storage areas of the physical storage enclosures as a virtual storage enclosure or enclosures; and grouping means for dividing the physical storage enclosures into a plurality of groups so as to constitute each virtual storage enclosure with the storage areas of the physical storage enclosures in the same group.

With this structure, the storage area of each virtual storage enclosure is constituted by the storage areas of the physical storage enclosures in the same group. When one of the physical storage enclosures in the same group has a breakdown or stops, the extent of influence can be easily known and restrained smaller.

In the storage virtualization apparatus, the grouping means may make a user, the host computer or other control enclosure divides the physical storage enclosures into the groups. In this case, the user, etc. can optionally divide the physical storage enclosures into the groups.

Further, the grouping means may divide the physical storage enclosures into the groups on the basis of characteristics of the physical storage enclosures.

For example, the characteristic or characteristics of each group are selected from access speed, RAID type, type of physical storage enclosure and model year. In this case, each virtual storage enclosure can have unique characteristic or characteristics.

Further, the storage virtualization apparatus may further comprise policy defining means for making a user, the host computer or other control enclosure defines the characteristics. With this structure, the storage virtualization apparatus can have the desired characteristics.

In the storage virtualization apparatus of the present invention, when the physical storage enclosure has a breakdown or stops, the host computer or computers within an extent of influence can be easily identified and the extent can be restrained smaller. Further, the storage virtualization apparatus has the sufficient characteristics required by the host computer.

### BRIEF DESCRIPTION OF THE DRAWINGS

Embodiments of the present invention will now be described by way of examples and with reference to the accompanying drawings, in which:

FIG. 1 is a block diagram of an embodiment of a storage virtualization apparatus of the present invention; and

FIG. 2 is a block diagram of the conventional storage virtualization apparatus.

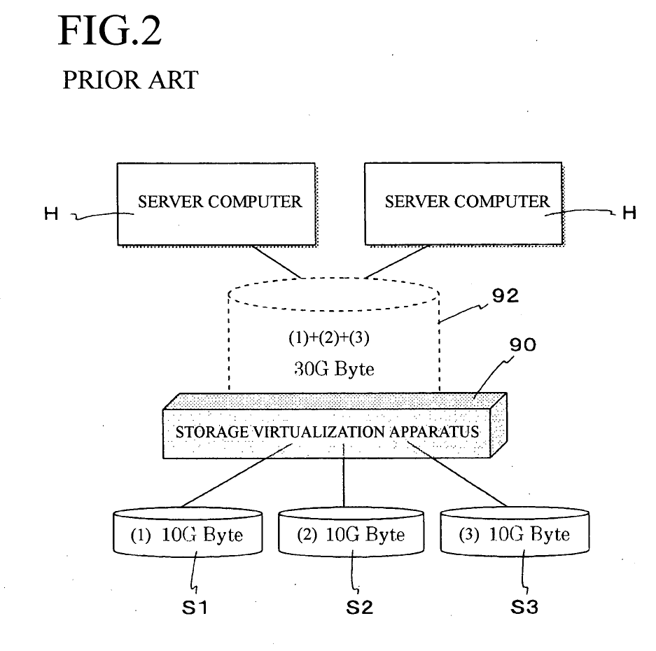

### DETAILED DESCRIPTION OF THE EMBODIMENTS

Preferred embodiments of the present invention will now be described in detail with reference to the accompanying drawings.

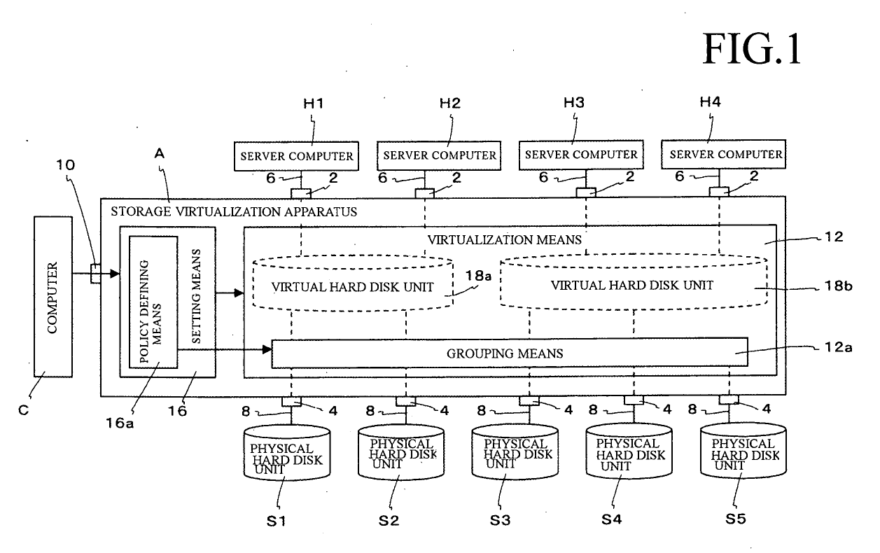

FIG. 1 is a block diagram of a storage virtualization apparatus A of the present invention.

The storage virtualization apparatus A comprises: a plurality of first connection means 2, which are respectively connected to server computers (host computers) H1, H2, H3 and H4; and a plurality of second connection means 4, which are respectively connected to physical hard disk enclosures (physical storage enclosures) S1, S2, S3, S4 and S5. The first connection means 2 and the second connection means 4 are fiber channel interfaces, to which cables 6 and 8, e.g., coaxial cables, optical fiber cables, corresponding to the server computers H1-4, the physical hard disk enclosures S1-5 and fiber channels are connected.

The virtual storage apparatus A has a terminal 10, to which another computer C, which is separated from the server computers H1-4 and which acts as a control enclosure, is connected.

The storage virtualization apparatus A includes a control section, which is constituted by a CPU, LSIs, ROMs, etc. The control section executes programs stored in the ROMs, performs functions of the LSIs.

By executing the programs stored in the ROMs, the control section act as virtualization means 12, grouping means 12a, setting means 16 and policy defining means 16a.

Outlines of the virtualization means 12, the grouping means 12a, the setting means 16 and the policy defining means 16a will be explained.

The setting means 16 determines how to virtualize the physical hard disk enclosures S1-5 on the basis of commands sent from the computer C and serve virtual storage areas to the server computers H1-4.

The policy defining means 16a defines policies for grouping the physical hard disk enclosures S1-5 on the basis of commands sent from the computer C.

Note that, the policies are data for grouping or dividing the physical hard disk enclosures S1-5 according to their characteristics. The data are, for example, access speed, RAID type, type of the physical storage enclosure and model year.

The grouping means 12a divides the physical hard disk enclosures S1-5 into a plurality of groups on the basis of the grouping policies defined by the policy defining means 16a.

The virtualization means 12 combines parts or all of storage areas of the physical storage enclosures S1-5 and makes the server computers H1-4 recognize the combined storage areas as virtual hard disk enclosures (virtual storage areas) 18a and 18b.

Successively, detail functions of the virtualization means 12, the grouping means 12a, the setting means 16 and the policy defining means 16a will be explained.

The user can input a command for how to virtualize the physical hard disk enclosures S1-5 to the computer C. The computer C sends the command to the storage virtualization apparatus A. The programs for inputting and sending the commands are previously stored in the computer C.

When the user inputs the commands, which include capacities of the virtual hard disk enclosures 18a and 18b and the grouping policies, the computer C sends data indicating the capacities, the grouping policies, etc. to the storage virtualization apparatus A together with commands for defining the virtualization.

A concrete example will be explained. In this example, the user inputs commands for forming the virtual hard disk enclosure having storage capacity of 20 GB and an access speed faster than a prescribed speed as a grouping policy.

When the storage virtualization apparatus A receives the commands from the computer C, the storage virtualization apparatus A sends a command for forming the virtual hard disk enclosure having storage capacity of 20 GB to the virtualization means 12. And, the policy defining means 16a sends the assigned grouping policy (the access speed faster than the prescribed speed) to the grouping means 12a.

The grouping means 12a reads characteristics data of the physical storage enclosures S1-5, which are connected to the storage virtualization apparatus A, and checks if their access speeds are faster than the prescribed speed of not. Further, the grouping means 12a selects, for example, the physical storage enclosures S1 and S2, whose access speeds are faster than the prescribed speed, as one group.

The virtualization means 12 selects unused parts of the storage areas of the physical storage enclosures S1 and S2, whose total storage capacity is 20 GB, and combined them as the virtual hard disk enclosure 18a. The virtualization means 12 serves the virtual hard disk enclosure 18a to the server computers.

The grouping means 12a sends specified data, e.g., ID numbers, of the selected physical storage enclosures S1 and S2 to the computer C. The computer C shows the data on its display enclosure, so that the user can know if the virtual hard disk enclosure is formed or not.

Note that, if no physical storage enclosures corresponding to the grouping policy are connected to the storage virtualization apparatus A or the total capacity of the combined storage areas is less than 20 GB, the grouping means 12a sends data, which indicate forming no virtual storage enclosure, to the computer C. The computer C shows the data on its display enclosure.

If a desired access speed of the virtual disk enclosure is faster than the prescribed speed so as to operate the server computers H1 and H2, the server computers H1 and H2 may be assigned to the virtual storage enclosure 18a.

Similarly, when the user inputs commands for forming a RAID type virtual hard disk enclosure as a grouping policy, the grouping means 12a selects, for example, the physical storage enclosures S3 and S4 as one group. Then, the virtualization means 12 selects unused parts of the storage areas of the physical storage enclosures S3 and S4 and combined them as the virtual hard disk enclosure 18b (see FIG. 1).

Unlike the conventional storage virtualization apparatus, the storage virtualization apparatus A of the present embodiment is capable of serving the virtual hard disk enclosures 18a and 18b, which have desired characteristics, to the server computers H1-4.

Even if one of the physical hard disk enclosures has a breakdown or stops, the server computers influenced by the breakdown or the stop are limited to the ones connected to the virtual hard disk enclosure constituted by the fault physical hard disk enclosure. Therefore, the server computers influenced by the breakdown or the stop can be easily known, and an extent of the influence can be restrained smaller.

Note that, the storage virtualization apparatus of the present invention is not limited to the above described embodiment. For example, the characteristics for grouping the physical disk enclosures are not limited to access speeds and RAID types. Many grouping data, e.g., type of physical hard disk enclosure, model year, may be used as the characteristics.

In the above described embodiment, the characteristics for grouping the physical hard disk enclosures are defined through the computer C (the control enclosure). The user may define or select the characteristics by, for example, dip switches of the storage virtualization apparatus A or the server computers H1-4.

Further, in the above described embodiment, the physical hard disk enclosures S1-5 are automatically divided into the groups. The user may directly select the physical hard disk enclosures of each of the groups by the computer C.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A storage virtualization apparatus,
comprising:
first connection means for connecting to a host computer;
second connection means for communicating with a plurality of physical storage enclosures;
virtualization means for making the host computer recognize a storage area constituted by parts or all of storage areas of the physical storage enclosures as a virtual storage enclosure or enclosures; and
grouping means for dividing the physical storage enclosures into a plurality of groups so as to constitute each virtual storage enclosure with the storage areas of the physical storage enclosures in the same group.

2. The storage virtualization apparatus according to claim 1,
wherein said grouping means makes a user, the host computer or other control enclosure divide the physical storage enclosures into the groups.

3. The storage virtualization apparatus according to claim 1,
wherein said grouping means divides the physical storage enclosures into the groups on the basis of characteristics of the physical storage enclosures.

4. The storage virtualization apparatus according to claim 3,
wherein the characteristic or characteristics of each group are selected from access speed, RAID type, type of physical storage enclosure and model year.

5. The storage virtualization apparatus according to claim 3,
further comprising policy defining means for making a user, the host computer or other control enclosure define the characteristics.
